(19) United States
(12) Patent Application Publication
(10) Pub. No.: US 2004/0226355 A1
(43) Pub. Date: Nov. 18, 2004

(54) Fuel leak test system for fuel injection system of diesel engine and methods thereof

(76) Inventor: Chang Rae Cho, Busan-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/839,854

(22) Filed: May 6, 2004

(30) Foreign Application Priority Data
May 15, 2003 (KR) 10-2003-0030938

(51) Int. Cl. F02D 7/00

(52) U.S. Cl. 73/119 A

(57) ABSTRACT

A fuel leak test system for a fuel injection system of a diesel engine includes a cranking device, a mixer, an ultraviolet ray lamp, an ID system, and a PLC. The cranking device cranks a diesel engine in an engine assembly line. The mixer mixes fuel with fluorescent material and supplies a mixture of the fuel and the fluorescent material to the diesel engine under a high pressure condition. The ultraviolet ray lamp irradiates an ultraviolet ray around the fuel injection system of the diesel engine. The ID system receives results of a fuel leak test based on a change of a color around the fuel injection system. The PLC receives the data on the fuel leak test from the ID system and controls operations of the fuel injection system and operations of devices of the engine assembly line.

### CROSS-REFERENCE TO RELATED APPLICATIONS

This application claims priority of Korean Application No. 10-2003-0030938, filed on May 15, 2003, the disclosure of which is incorporated fully herein by reference.

### FIELD OF THE INVENTION

The present invention relates to systems and methods for determining a fuel leak in a fuel injection system of a diesel engine.

### BACKGROUND OF THE INVENTION

Typically, a diesel engine is provided with a fuel injection system that compresses the fuel to a high pressure and supplies the pressurized fuel into a combustion chamber of the engine. Such a fuel injection system for the diesel engine often includes a high pressure pump, a common rail, a fuel pressure regulator, and an injector. Fuel that is pressurized to a high pressure by the high pressure pump is supplied to a combustion chamber through the common rail that is connected to a high pressure pipe and the injector.

Because the fuel is under high pressure, the fuel can often leak at a case coupling portion of the high pressure pump, a port-connecting portion of the high pressure pipe, a connecting portion of a cylinder block, a connecting portion of the common rail, a connecting portion of the fuel pressure regulator, a connecting portion of the injector, or other locations of the system.

Often, in a process for testing an assembled engine in an engine assembly line, a fuel leak test for a fuel injection system of the diesel engine is performed in parallel with the engine performance test. That is, following complete assembly of the diesel engine, a firing test is performed and engines that do not pass the firing test are reassembled. During this firing test, a worker also performs a fuel leak test. Often the fuel leak test is simply performed with unaided eyes of the worker. However, because the fuel is transparent and noises and vibrations are generated during the firing test, it is difficult for the worker to detect a fuel leak. Therefore, it would be advantageous to have a system and method for specifically testing for leakage in the fuel system.

The information disclosed in this Background of the Invention section is only for enhancement of understanding of the background of the invention and should not be taken as an acknowledgement or any form of suggestion that this information forms the prior art that is already known to a person of ordinary skill in the art.

### SUMMARY OF THE INVENTION

An embodiment of the present invention provides fuel leak test systems and methods thereof for a fuel injection system of a diesel engine in which a fuel leak can be accurately detected.

In a preferred embodiment of the present invention, the fuel leak test system includes a mixer, an engine cranking device, an ultraviolet ray lamp, an ID (identification) system, and a PLC (programmable logic controller). The mixer mixes fuel and fluorescent material. The engine cranking device turns a diesel engine that is supplied with a mixture of the fuel and the fluorescent material. The ultraviolet ray lamp irradiates an ultraviolet ray around the fuel injection system of the engine. The ID system is configured receive results of a fuel leak test as input based on a change of color around the fuel injection system from the ultraviolet ray lamp irradiating any leaking fluorescent material. The PLC is configured to receive the data on the fuel leak test from the ID system and control operations of the fuel injection system.

Preferably the engine cranking device comprises a motor and an air cylinder. The motor provides a rotational force for rotating the engine. The air cylinder advances or retreats a rotating axis coupler that couples with and separates from the motor, thereby engaging the rotational force with the engine or separating the rotating force from the engine.

In a preferred embodiment of the present invention, the control algorithm for a fuel leak test system includes connecting an engine cranking device to an assembled diesel engine and cranking the diesel engine by operating the engine cranking device. While cranking the engine a mixture of fuel and fluorescent material is supplied to a fuel injection system of the diesel engine. The fuel injection system is irradiated with an ultraviolet ray by operating an ultraviolet ray lamp. Next, it is determined whether there is a fuel leak by analyzing any change of color around the fuel injection system while it is irradiated b the ultraviolet ray. If a change of color is detected, the engine is reassembled. The engine cranking device is also separated from the diesel engine and the engine is discharged from a testing station by operating a power conveyor unit upon determined that there is no fuel leak.

In another preferred embodiment, the fuel leak test system for a fuel injection system of a diesel engine comprises a cranking device, a mixer, an ultraviolet ray lamp, an ID system, and a PLC. The cranking device is configured to crank a diesel engine while the engine is in an engine assembly line. The mixer is configured to mix fuel with a fluorescent material and to supply the mixture of the fuel and the fluorescent material to the diesel engine. The ultraviolet ray lamp is configured to irradiate ultraviolet ray around a fuel injection system of the diesel engine. The ID system is configured to have results of a fuel leak test input thereinto based on a change of a color around the fuel injection system while the ultraviolet ray lamp irradiates ultraviolet around the fuel injection system. The PLC is configured to receive data on the fuel leak test from the ID system and to control operations of the fuel injection system and operations of devices of the engine assembly line.

It is also preferable that the cranking device comprises a motor and an air cylinder. The motor provides a rotational force, and the air cylinder advances or retreats a rotating axis coupler of the motor such that the rotating axis coupler is connected to the diesel engine or is separated from the diesel engine.

In another embodiment of the present invention, the fuel leak test method for a fuel injection system of a diesel engine includes cranking the diesel engine in an engine assembly line, supplying a mixture of fuel and fluorescent material to the diesel engine through the fuel injection system, irradiating an ultraviolet ray around the fuel injection system, and determining whether there is a fuel leak based on a change of color around the fuel injection system while the ultraviolet ray is irradiating the fuel injection system.

Preferably, the fuel leak test method further comprises controlling operations of devices of the engine assembly line based on a result of the fuel leak test.

### BRIEF DESCRIPTION OF THE DRAWINGS

The accompanying drawings, which are incorporated in and constitute a part of the specification, illustrate an embodiment of the invention, and, read together with the description, serve to explain the principles of the invention, where:

FIG. 1 is a perspective view of a fuel injection system of a diesel engine;

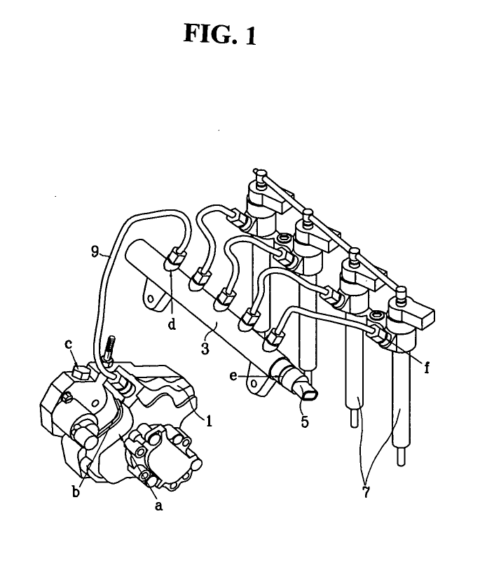

FIG. 2 is a flowchart of an embodiment of a fuel leak test according to the present invention;

FIG. 3 schematically shows a fuel leak test system according to an embodiment of the present invention; and

FIG. 4 is a flowchart of a fuel leak test method according to an embodiment of the present invention.

### DETAILED DESCRIPTION OF A PREFERRED EMBODIMENT

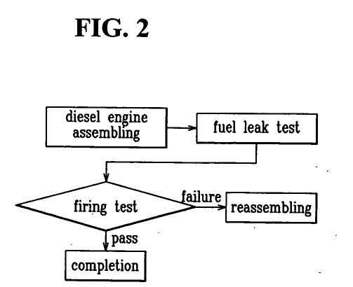

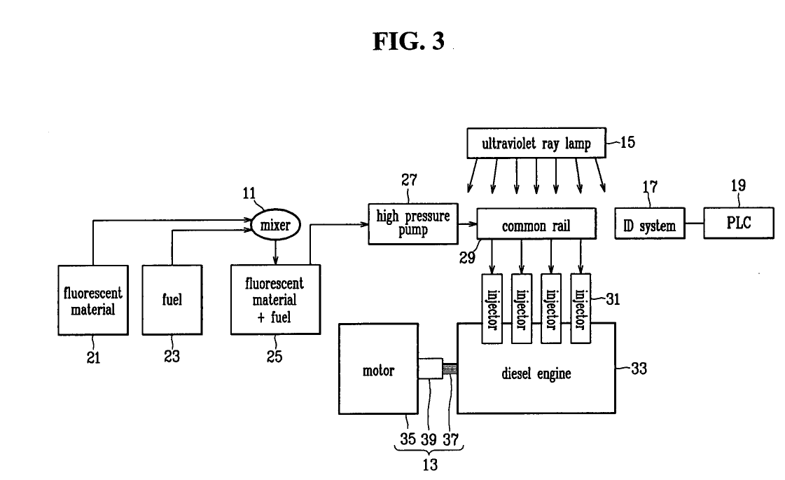

According to FIG. 2, a fuel leak test is separately performed from a firing test for a diesel engine. That is, the firing test is performed only for a diesel engine that has passed the fuel leak test. The fuel leak test system according to an embodiment of the present invention, as shown in FIG. 3, includes a mixer 11, an engine cranking device 13, an ultraviolet ray lamp 15, an ID system 17, and a PLC 19.

The mixer 11 is configured to mix fuel from a fuel tank 23 with fluorescent material from a fluorescent material tank 21. The mixture is then supplied to a mixture tank 25. Because the fluorescent material is mixed with fuel, visibility of the mixture of fuel and fluorescent material is improved, when compared to the visibility of pure fuel. Preferably, a ratio of the fuel and the fluorescent material is about 10:1.

According to FIG. 3, the mixture of the fuel and the fluorescent material within the mixture tank 25 is supplied to a diesel engine 33 in a highly pressurized state through a common rail 29 and injectors 31 by an operation of a high pressure pump 27. The engine cranking device 13 is configured to crank the diesel engine 33. The engine cranking device 13 preferably includes a motor 35 that provides a rotational force for cranking the engine. Furthermore, the engine cranking device 13 includes an air cylinder 39 that advances or retreats a rotating axis coupler 37 of the motor 35 and engages or disengages the cranking device 13 with the engine. In response to operations of the air cylinder 39, the rotating axis coupler 37 of the motor 35 is connected to the diesel engine 33 or is separated from the diesel engine 33, so that the power of the motor 35 can be selectively transmitted to the diesel engine 33.

The diesel engine 33 is supplied with the mixture of fuel and fluorescent material by the mixer 11. The ultraviolet ray lamp 15 is configured to emit an ultraviolet ray around a fuel injection system including the high pressure pump 27, the common rail 29, and the injector 31. If, during use, the mixture of fuel and fluorescent material leaks from the fuel injection system a change of color around fuel leak positions will occur. Consequently, by irradiating the ultraviolet ray around the fuel injection system, a person who performs the fuel leak test can easily detect a fuel leak.

The ID system 17 is widely used in an engine assembly line for identifying types of engines. It includes various data such as sequence order, working information, and engine type information. The ID system 17 preferably includes various components for data input and data communication such as an ID card, an ID antenna, an ID controller, an ID reader, an ID writer, and the like. Furthermore, in an embodiment of the present invention, the ID system 17 is configured to have data on fuel leak determination input thereto, such data being based on a change of color around the fuel injection system by the irradiation of the ultraviolet ray interacting with the fuel and fluorescent material.

The PLC 19 receives data on the fuel leak determination from the ID system 17. The PLC 19 controls operations of the engine cranking device 13, the high pressure pump 27, the injector 31, and various devices of the engine assembly line, based on the fuel leak data.

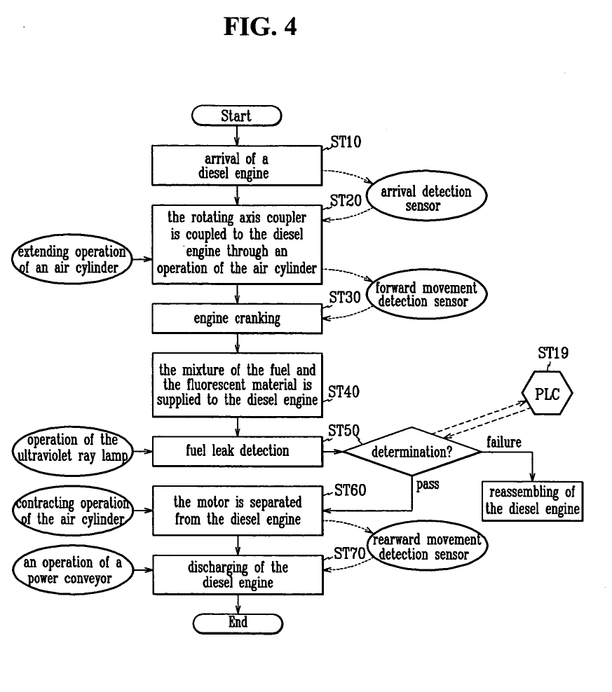

A control algorithm of the fuel leak test system as stated above is shown in FIG. 4. Initially, in step ST10, the assembled diesel engine arrives at a specific position that is separate from a position for the firing test. After the leak test is performed, a firing test is performed. That is, the firing test is performed only for an assembled diesel engine that has passed the fuel leak test. The arrival of the assembled diesel engine can be detected by an arrival detection sensor. After the diesel engine 33 arrives at a testing position, the rotating axis coupler 37 of the motor 35 is coupled to the diesel engine 33 through the operation of the air cylinder 39. The motor 35 then operates, thereby cranking the diesel engine 33, in step ST30. Forward movement of the rotating axis coupler 37 can preferably be detected by a forward movement detection sensor.

During the cranking step ST30, a fuel supply step ST40 is performed. In the fuel supply step ST 40, the high pressure pump 27 is operated in response to the cranking of the diesel engine 33 and thereby the mixture of fuel and fluorescent material is supplied through the common rail 29 and the injector 31 to the diesel engine 33.

After the fuel supply step ST40, a fuel leak detection step ST50 is performed. In the fuel leak detection step ST50, the ultraviolet ray lamp 15 is operated to irradiate the ultraviolet ray around the fuel injection system. If the mixture leaks from the fuel injection system, it is detected visually by a color change due to interaction of the ultraviolet light with the fluorescent material of the mixture. The fuel leak detection step ST50 can include a step for inputting results of the fuel leak test to the ID system 17 and a step for transmitting the results of the fuel leak test from the ID system 17 to the PLC 19. The PLC 19, as stated above, controls operations of the engine cranking device 13, the high pressure pump 27, the injector 31, and various devices of the engine assembly line, based on the result of the fuel leak test. If it is determined that there is a fuel leak in the fuel leak detection step ST50, the diesel engine 33 is then scheduled to be reassembled.

On the other hand, if it is determined that there is no fuel leak in the fuel leak detection step ST50, the rotating axis coupler 37 of the motor 35 is separated from the diesel engine 33 through an operation of the air cylinder 39, in step ST60. The rearward movement of the rotating axis coupler 37 can preferably be detected by a rearward movement detection sensor. After the step ST60, a diesel engine discharging step ST70 is performed. In the diesel engine discharging step ST70, the engine cranking device 13 is retreated and the diesel engine 33 is discharged from the assembly line through an operation of a power conveyor.

According to the embodiments of the present invention, by supplying the mixture of the fuel and the fluorescent material to the diesel engine, irradiating the ultraviolet ray around the fuel injection system, and then determining whether there is a fuel leak, the fuel leak test can be easily performed.

Although preferred embodiments of the present invention have been described in detail hereinabove, it should be clearly understood that many variations and/or modifications of the basic inventive concepts herein taught which may appear to those of ordinary skill in the art will fall within the spirit and scope of the present invention, as defined in the appended claims.

What is claimed is:

1. A fuel leak test system for a fuel injection system of a diesel engine, comprising:
a mixer for mixing fuel and fluorescent material;
an engine cranking device for cranking a diesel engine that is supplied with a mixture of fuel and fluorescent material by the mixer;
an ultraviolet ray lamp for irradiating an ultraviolet ray upon the fuel injection system;
an ID system that is configured to have results of a fuel leak test input thereto, the results being based on a change of color around the fuel injection system while the ultraviolet ray lamp irradiates an ultraviolet ray around the fuel injection system; and
a PLC configured to receive data on the fuel leak test from the ID system and to control operations of the fuel injection system.

2. The fuel leak test system of claim 1, wherein the engine cranking device comprises:
a motor for providing a rotational force; and
an air cylinder for advancing or retreating a rotating axis coupler of the motor such that the rotating axis coupler is connected to the diesel engine or is separated from the diesel engine.

3. A control method for a fuel leak test system for a fuel injection system of a diesel engine, comprising:
connecting an engine cranking device to an assembled diesel engine;
cranking the diesel engine by operating the engine cranking device;
supplying a mixture of fuel and fluorescent material to a fuel injection system of the diesel engine if the engine is cranked;
irradiating an ultraviolet ray around the fuel injection system by operating an ultraviolet ray lamp;
determining whether there is a fuel leak based on a change of color around the fuel injection system while the ultraviolet ray is irradiated;
reassembling the diesel engine if it is determined that there is a fuel leak;
separating the engine cranking device from the diesel engine; and
discharging the diesel engine by operating a power conveyor if it is determined that there is no fuel leak.

4. A fuel leak test system for a fuel injection system of a diesel engine, comprising:
a cranking device configured to crank a diesel engine in an engine assembly line;
a mixer configured to mix fuel with fluorescent material, the mixer configured to supply a mixture of the fuel and fluorescent material to the diesel engine;
an ultraviolet ray lamp configured to irradiate an ultraviolet ray around a fuel injection system of the diesel engine;
an ID system configured to have results of a fuel leak test input thereto, the results being based on a change of a color around the fuel injection system while the ultraviolet ray lamp irradiates an ultraviolet ray around the fuel injection system; and
a PLC configured to receive data on the fuel leak test from the ID system and to control operations of the fuel injection system and operations of devices of the engine assembly line.

5. The fuel leak test system of claim 4, wherein the cranking device comprises:
a motor for providing a rotational force; and
an air cylinder for advancing or retreating a rotating axis coupler of the motor such that the rotating axis coupler is connected to the diesel engine or is separated from the diesel engine.

6. A fuel leak test method for a fuel injection system of a diesel engine, comprising:
cranking the diesel engine in an engine assembly line;
supplying a mixture of fuel and fluorescent material to the diesel engine through the fuel injection system;
irradiating an ultraviolet ray around the fuel injection system; and
determining whether there is a fuel leak based on a change of color around the fuel injection system while the ultraviolet ray is irradiated around the fuel injection system.

7. The fuel leak test method of claim 6, further comprising controlling operations of devices of the engine assembly line based on a result of the fuel leak test.
